(19) United States
(12) Patent Application Publication
(10) Pub. No.: US 2023/0144476 A1
(43) Pub. Date: May 11, 2023

(54) Acid-Blocked Alkylaminopyridine Catalysts For Polyurethane Foam

(71) Applicant: Huntsman Petrochemical LLC, The Woodlands, TX (US)

(72) Inventors: Matthew T Meredith, The Woodlands, TX (US); DiAnne Pham, The Woodlands, TX (US)

(21) Appl. No.: 17/915,046

(22) PCT Filed: Mar. 12, 2021
(86) PCT No.: PCT/US2021/022080

§ 371 Date: Sep. 27, 2022

Related U.S. Application Data
(60) Provisional application No. 63/000,897, filed on Mar. 27, 2020.

(51) Int. Cl. C08G 18/20; C08G 18/76; C08J 9/14; C09D 5/00; C09D 5/02; C09D 175/04; C09J 175/04; C09J 11/06; C09K 3/10

(52) U.S. Cl. CPC C08G 18/2081; C08G 18/2018; C08G 18/7671; C08J 9/146; C09D 5/002; C09D 5/021; C09D 175/04; C09J 175/04; C09J 11/06; C09K 3/1021; C08G 2150/60; C08G 2110/0025; C08G 2110/0008; C08G 2170/60; C08J 2203/162; C08J 2205/06; C08J 2205/10; C08J 2207/02; C08J 2207/04; C08J 2375/04; C09K 2200/065

(57) ABSTRACT

The present disclosure relates to acid-blocked alkylaminopyridine catalysts for use in a polyurethane formulation. The polyurethane formulation may include the acid-blocked alkylaminopyridine catalyst, a compound containing an isocyanate functional group, an active hydrogen-containing compound and a halogenated olefin compound.

### CROSS-REFERENCE TO RELATED APPLICATION

This application is the National Phase of International Application PCT/US2021/022080 filed Mar. 12, 2021 which designated the U.S. and which claim priority to U.S. Provisional Application 63/000,897 filed Mar. 27, 2020. The noted applications are incorporated herein by reference.

### STATEMENT REGARDING FEDERALLY SPONSORED RESEARCH OR DEVELOPMENT

Not applicable.

### FIELD

The present disclosure generally relates to acid-blocked alkylaminopyridine catalysts for use in the production of flexible and rigid polyurethane foam and other polyurethane materials.

### BACKGROUND

Polyurethane foams are widely known and used in a variety of applications, such as in the automotive and housing industry. For example, sprayable polyurethane foam is typically comprised of an isocyanate (“A-side”) and polyol resin blend (“B-side”) that are co-mixed and immediately sprayed onto a substrate which often times is a vertical wall or ceiling. In addition to a polyol or mixture of polyols, the B-side can also include surfactants, flame retardants, physical blowing agents, water, and catalysts which accelerate the foam reaction and are therefore integral to the performance of the sprayable polyurethane foam. This fine-tuned mixture allows the polyurethane mixture to contact the substrate, foam up, and cure in less than a minute. Of particular importance is the “front end” of the reaction, also known as the creaming or blowing portion of the foaming process. The creaming must be very rapid when sprayed, typically less than 1 second, to cause the A-side and B-side mixture to increase in viscosity and avoid dripping down the wall or onto the applicator (if the substrate is a ceiling). Fast cream times are achieved with catalysts that accelerate either physical or chemical blowing. Chemical blowing occurs when CO₂ gas is generated from the reaction of an isocyanate and water, and physical blowing occurs when a volatile liquid (the blowing agent) vaporizes from the heat of the polyurethane reaction. In practice, chemical and physical blowing are important and contribute to stable spray foam formation.

Traditionally, strong tertiary amine catalysts have been used to give fast cream times. Tertiary catalysts which contain a high concentration of dimethylamino groups have a more alkaline pKa, a two-carbon spacing between heteroatoms, and are not sterically hindered, and therefore are typically good blowing catalysts. Commercially available examples of such catalysts are JEFFCAT® ZF-20 catalyst, JEFFCAT® ZF-10 catalyst, and JEFFCAT® PMDETA catalyst (from Huntsman Corporation). These catalysts and others have met the demands needed for strong blowing catalysts for many years.

New environmental regulations around the world have mandated the use of new, “low global warming potential” (GWP) blowing agents which degrade much faster in the atmosphere and do not contribute appreciably to the greenhouse effect or degrade the ozone layer, as previous generations of blowing agents and refrigerants are known to do. These favorable environmental properties are obtained by the presence of double bond(s) in the blowing agent molecule, in addition to a number of hydrogen and halogen atoms, which allows for fast breakdown in the environment. However, an unfortunate side effect of using these low GWP blowing agents, or hydrofluoro-olefins (HFOs), is that they tend to degrade when they are in contact with many of the commercially available amine blowing catalysts. This instability significantly shortens the shelf life of polyol resin blends that contain HFO blowing agents.

Various attempts have been made to improve the shelf life of blends containing amines and HFO blowing agents without affecting their ability to catalyze polyurethane foam formulation at a reasonable rate. Most of these attempts center around using amines that are deactivated in one way or another (ie sterically hindered or bonded with electron withdrawing groups) or by including further additives to prevent their reaction with the HFO blowing agent such as carboxylic acids (see, for e.g., U.S. Pat. No. 10,023,681, US Pat. Publ. No. 2015/0266994A1, US Pat. Publ. No. 2016/0130416A1, U.S. Pat. Nos. 9,550,854, 9,556,303, 10,308,783, 9,868,837 and US Pat. Publ. No. 2019/0177465A1). However, such attempts have yet to achieve blends that have shelf-life stability and catalytic activity comparable to blends containing amines and standard non-halogenated blowing agents. Thus, there is a continuing need for the development of new amine catalysts for use in producing rigid, flexible or spray polyurethane foam and other polyurethane materials which may be combined with the newer HFO blowing agents to form a blend having acceptable catalytic activity and an improved shelf life over the current conventional amine catalysts/non-halogenated blowing agent blends.

Alkylaminopyridines such as N,N-dimethyl-4-aminopyridine are strongly nucleophilic amines that have been evaluated for many organic synthetic reactions (Angew. Chrm. Int. Ed. Engl. 17,569-583 (1978)). Among these reactions is the reaction between alcohols or polyols and isocyanates—the so-called “gelling” reaction (U.S. Pat. Nos. 3,109,825, 3,144,452, and 3,775,376). When used in these systems, it is a very strong catalyst, comparable with triethylenediamine. However, in prior art, it is used in its neutral form and does not promote the blowing reaction between isocyanates and water. We have surprisingly found that when alkylaminopyridines are acid-blocked they promote rapid blowing in polyurethane foam formulations.

### SUMMARY

The present disclosure provides a polyurethane formulation comprising an acid-blocked alkylaminopyridine catalyst, a halogenated olefin compound, a compound containing an isocyanate functional group and an active hydrogen-containing compound.

According to another embodiment, there is provided a catalyst package for use in forming a polyurethane material comprising an acid-blocked alkylaminopyridine catalyst and a halogenated olefin compound.

In yet another embodiment, there is provided a method of forming a polyurethane material comprising contacting a compound containing an isocyanate functional group, an active hydrogen-containing compound and optional auxiliary components in the presence of an acid-blocked alkylaminopyridine catalyst and a halogenated olefin compound.

### BRIEF DESCRIPTION OF THE DRAWINGS

FIG. 1 depicts the % change in cream times and top of cup times for polyurethane foams produced using industry standard catalysts that are blocked with formic acid as well as with the inventive alkylaminopyridine catalysts blocked with either formic acid, acetic acid, or 2-ethhylhexanoic acid;

FIG. 2 depicts the reaction profiles for polyurethane foams produced using an inventive acid-blocked alkylaminopyridine catalyst either alone or with an acid-blocked industry standard catalyst; and

FIG. 3 depicts the change in the reaction profile of polyurethane foams made with heat-aged polyol resin blends containing the inventive acid-blocked alkylaminopyridine.

### DETAILED DESCRIPTION

The following terms shall have the following meanings:

The term “comprising” and derivatives thereof are not intended to exclude the presence of any additional component, step or procedure, whether or not the same is disclosed herein. In order to avoid any doubt, all compositions claimed herein through use of the term “comprising” may include any additional additive or compound, unless stated to the contrary. In contrast, the term, “consisting essentially of” if appearing herein, excludes from the scope of any succeeding recitation any other component, step or procedure, except those that are not essential to operability and the term “consisting of”, if used, excludes any component, step or procedure not specifically delineated or listed. The term “or”, unless stated otherwise, refers to the listed members individually as well as in any combination.

The articles “a” and “an” are used herein to refer to one or to more than one (i.e. to at least one) of the grammatical objects of the article. By way of example, “a catalyst” means one catalyst or more than one catalyst. The phrases “in one embodiment”, “according to one embodiment” and the like generally mean the particular feature, structure, or characteristic following the phrase is included in at least one embodiment of the present disclosure, and may be included in more than one embodiment of the present disclosure. Importantly, such phrases do not necessarily refer to the same aspect. If the specification states a component or feature “may”, “can”, “could”, or “might” be included or have a characteristic, that particular component or feature is not required to be included or have the characteristic.

The term “about” as used herein can allow for a degree of variability in a value or range, for example, it may be within 10%, within 5%, or within 1% of a stated value or of a stated limit of a range.

Values expressed in a range format should be interpreted in a flexible manner to include not only the numerical values explicitly recited as the limits of the range, but to also include all of the individual numerical values or sub-ranges encompassed within that range as if each numerical value and sub-range is explicitly recited. For example, a range such as from 1 to 6, should be considered to have specifically disclosed sub-ranges, such as, from 1 to 3, from 2 to 4, from 3 to 6, etc., as well as individual numbers within that range, for example, 1, 2, 3, 4, 5, and 6. This applies regardless of the breadth of the range.

The terms “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the present disclosure.

The term “substantially free” refers to a composition in which a particular compound or moiety is present in an amount that has no material effect on the composition. In some embodiments, “substantially free” may refer to a composition in which the particular compound or moiety is present in the composition in an amount of less than 2% by weight, or less than 1% by weight, or less than 0.5% by weight, or less than 0.1% by weight, or less than 0.05% by weight, or even less than 0.01% by weight based on the total weight of the composition, or that no amount of that particular compound or moiety is present in the respective composition.

The term “mineral acid” refers to an acid that does not contain carbon. Examples of mineral acids include, but are not limited to, the following acids: hydrochloric acid, hydrobromic acid, nitric acid, phosphoric acid, sulfuric acid, boric acid, hydrofluoric acid, and perchloride.

Where substituent groups are specified by their conventional chemical formula, written from left to right, they equally encompass the chemically identical substituents that would result from writing the structure from right to left, for example, —CH₂O— is equivalent to —OCH₂—.

The term “alkyl” refers to straight chain or branched chain saturated hydrocarbon groups having from 1 to 10 carbon atoms or from 1 to 8 carbon atoms or from 1 to 6 carbon atoms. In some embodiments, alkyl substituents may be lower alkyl groups. The term “lower” refers to alkyl groups having from 1 to 6 carbon atoms. Examples of “lower alkyl groups” include, but are not limited to, methyl, ethyl, n-propyl, i-propyl, butyl, and pentyl groups.

The term “halogenated olefin” refers to an olefin compound or moiety which may include fluorine, chlorine, bromine or iodine.

The term “optional” or “optionally” means that the subsequently described event or circumstance may or may not occur, and that the description includes instances where said event or circumstance occurs and instances where it does not.

The present disclosure is generally directed to novel acid-blocked alkylaminopyridine catalysts and their use in polyurethane formulations which may include a compound containing an isocyanate functional group, an active hydrogen-containing compound and a halogenated olefin compound as a blowing agent. The present disclosure is also directed to rigid, flexible or spray polyurethane foam or other polyurethane material made from a formulation comprising an acid-blocked alkylaminopyridine catalyst as described herein, a compound containing an isocyanate functional group, an active hydrogen-containing compound and a halogenated olefin compound as a blowing agent. The term “polyurethane” as used herein, is understood to encompass pure polyurethane, polyurethane polyurea, and pure polyurea. It has been surprisingly found combining a halogenated olefin compound blowing agent with an acid-blocked alkylaminopyridine catalyst according to the present disclosure leads to a polyurethane mixture having improved front end stability and catalytic activity.

According to one embodiment, the acid-blocked alkylaminopyridine catalyst is one or more catalysts obtained by contacting (i) at least one alkylaminopyridine of formula (1) or (2)

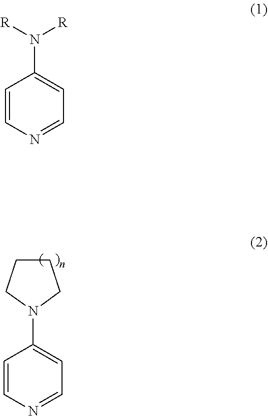

with (ii) at least one of a mineral acid or a carboxylic acid of formula (3)

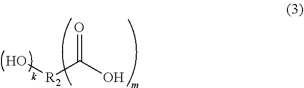

where each R is independently an alkyl group, hydroxyethyl group or hydroxypropyl group, n is an integer from 1 to 2, R₂ is hydrogen, an alkyl group, an alkenyl group, cycloaliphatic group, an aromatic group, or alkylaromatic group, k and m are independently an integer from 0 to 3 with the proviso that k+m≥1 and when k=1 and m=0, R is an aromatic group or alkylaromatic group.

According to one embodiment, the R alkyl groups include, but are not limited to, methyl, ethyl, n-propyl, iso-propyl and butyl. In another embodiment, the R₂ alkyl groups include, but are not limited to, methyl, ethyl, n-propyl, iso-propyl, propyl, butyl, iso-butyl, n-amyl, n-decyl or 2 ethylhexyl.

Particular compounds that may be used as the carboxylic acid of formula (3) include, but are not limited to, a hydroxyl-carboxylic acid, a di-carboxylic acid, formic acid, acetic acid, malonic acid, glutaric acid, maleic acid, glycolic acid, lactic acid, 2-hydroxybutyric acid, citric acid, AGS acid, phenol, cresol, hydroquinone, or combinations thereof. AGS acid is a mixture of dicarboxylic acids (i.e., adipic acid, glutaric acid, and succinic acid) that is obtained as a by-product of the oxidation of cyclohexanol and/or cyclohexanone in the adipic acid manufacturing process. Suitable AGS acid that may be used as the carboxylic acid of formula (3) include RHODIACID® acid (available from Solvay S.A.), DIBASIC acid (available from Invista S.a.r.1), FLEXATRAC™-AGS-200 acid (available from Ascend Performance Materials LLC), and glutaric acid, technical grade (AGS) (available from Lanxess A.G.).

In one embodiment, the acid-blocked alkylaminopyridine catalyst may be prepared in situ in the polyurethane formulation by adding at least one of the alkylaminopyridines of formula (1), (2) and the at least one of the mineral acid or carboxylic acid of formula (3) to the polyurethane formulation, while in other embodiments, the acid-blocked alkylaminopyridine catalyst above may be prepared prior to addition to the polyurethane formulation by contacting the least one of the alkylaminopyridines of formula (1), (2) with the at least one of the mineral acid or carboxylic acid of formula (3) in a vessel or in-line mixer to form the acid-blocked alkylaminopyridine catalyst and then adding the acid-blocked alkylaminopyridine catalyst to the polyurethane formulation.

According to some embodiments, the acid-blocked alkylaminopyridine may be used as the only catalyst in forming the polyurethane foam or material. In still other embodiments, the acid-blocked alkylaminopyridine catalyst above may be combined with another amine catalyst containing at least one tertiary amine group, which can also include these amine catalysts acid-blocked with a mineral acid or carboxylic acid of formula (3), and/or a non-amine catalyst in forming the polyurethane foam or material. In embodiments in which the acid-blocked alkylaminopyridine catalyst is combined with an amine catalyst containing at least one tertiary amine group (and including such amine catalysts that have been acid-blocked with a mineral acid or carboxylic acid of formula (3)) and/or a non-amine catalyst, the weight ratio of the acid-blocked alkylaminopyridine catalyst to the amine catalyst containing at least one amine group and/or the non-amine catalyst is at least 1:1, and in some embodiments, at least 1.5:1 and in still other embodiments at least 2:1 and in further embodiments at least 5:1, while in still further embodiments at least 10:1. In still other embodiments, the weight ratio of the acid-blocked alkylaminopyridine catalyst to the amine catalyst containing at least one amine group and/or the non-amine catalyst is from 0.1:99.9 to 99.9:0.1, and in still other embodiments from 1:99 to 99:1, and in still other embodiments from 5:95 to 95:5, and in further embodiments from 10:90 to 90:10, while in still further embodiments from 25:75 to 75:25, while in still other embodiments from 35:65 to 65:35, while in still other embodiments from 40:60 to 60:40.

Representative amine catalysts containing at least one tertiary group include, but are not limited to, bis-(2-dimethylaminoethyl)ether (JEFFCAT® ZF-20 catalyst), N,N,N′-trimethyl-N′-hydroxyethylbisaminoethylether (JEFFCAT® ZF-10 catalyst), N-(3-dimethylaminopropyl)-N,N-diisopropanolamine (JEFFCAT® DPA catalyst), N,N-dimethylethanolamine (JEFFCAT® DMEA catalyst), triethylene diamine (JEFFCAT® TEDA catalyst), blends of N,N-dimethylethanolamine ethylene diamine (such as JEFFCAT® TD-20 catalyst), N,N-dimethylcyclohexylamine (JEFFCAT® DMCHA catalyst), benzyldimethylamine (JEFFCAT® BDMA catalyst), pentamethyldiethylenetriamine (JEFFCAT® PMDETA catalyst), N,N,N′,N″,N″-pentamethyldipropylenetriamine (JEFFCAT® ZR-40 catalyst), N,N-bis(3-dimethylaminopropyl)-N-isopropanolamine (JEFFCAT® ZR-50 catalyst), N′-(3-(dimethylamino)propyl-N,N-dimethyl-1,3-propanediamine (JEFFCAT® Z-130 catalyst), 2-(2-dimethylaminoethoxy)ethanol (JEFFCAT® ZR-70 catalyst), N,N,N-trimethylaminoethyl-ethanolamine (JEFFCAT® Z-110 catalyst), N-ethylmorpholine (JEFFCAT® NEM catalyst), N-methylmorpholine (JEFFCAT® NMM catalyst), 4-methoxyethylmorpholine, N,N′dimethylpiperzine (JEFFCAT® DMP catalyst), 2,2′-dimorpholinodiethylether (JEFFCAT® DMDEE catalyst), 1,3,5-tris(3-(dimethylamino)propyl)-hexahydro-s-triazine (JEFFCAT® TR-90 catalyst), 1-propanamine, 3-(2-(dimethylamino)ethoxy), substituted imidazoles such as 1,2-dimethlyimidazol and 1-methyl-2-hydroxyethylimidazole, N,N′-dimethylpiperazines or bis-substituted piperazines such aminoethylpiperazine, N,N′,N′-trimethyl aminoethylpiperazine or bis-(N-methyl piperazine)urea, N-methylpyrrolidines and substituted methylpyrrolidines such as 2-aminoethyl-N-methylpyrrolidine or bis-(N-methylpyrrolidine)ethyl urea, 3-dimethylaminopropylamine, N,N,N″,N″-tetramethyldipropylenetriamine, tetramethylguanidine, 1,2-bis-diisopropanol. Other examples of amine catalysts include N-alkylmorpholines, such as N-methylmorpholine, N-ethylmorpholine, N-butylmorpholine and dimorpholinodiethylether, N,N′-dimethylaminoethanol, N,N-dimethylamino ethoxyethanol, bis-(dimethylaminopropyl)-amino-2-propanol, bis-(dimethylamino)-2-propanol, bis-(N,N-dimethylamino)ethylether; N,N,N′-trimethyl-N′hydroxyethyl-bis-(aminoethyl)ether, N,N-dimethyl amino ethyl-N′-methyl amino ethanol and tetramethyliminobispropylamine. The aforementioned JEFFCAT® catalysts are available from Huntsman Petrochemical LLC, The Woodlands, Tex.

Other amine catalysts which may be used in the present disclosure may be found in Appendix D in “Dow Polyurethanes Flexible Foams” by Herrington et al. at pages D.1-D.23 (1997), which is incorporated herein by reference. Further examples may be found in “JEFFCAT® Amine Catalysts for the Polyurethane Industry” version JCT-0910 which is incorporated herein by reference.

The non-amine catalyst is a compound (or mixture thereof) having catalytic activity for the reaction of an isocyanate group with a polyol or water, but is not a compound falling within the description of the amine catalyst above. Examples of such additional non-amine catalysts include, for example:

tertiary phosphines, such as trialkylphosphines and dialkylbenzylphosphines;

chelates of various metals, such as those which can be obtained from acetylacetone, benzoylacetone, trifluoroacetyl acetone, ethyl acetoacetate and the like, with metals such as Be, Mg, Zn, Cd, Pd, Ti, Zr, Sn, As, Bi, Cr, Mo, Mn, Fe, Co and Ni;

metal carboxylates such as potassium acetate and sodium acetate;

acidic metal salts of strong acids, such as ferric chloride, stannic chloride, stannous chloride, antimony trichloride, bismuth nitrate and bismuth chloride;

strong bases, such as alkali and alkaline earth metal hydroxides, alkoxides and phenoxides;

alcoholates and phenolates of various metals, such as Ti(OR⁶)₄, Sn(OR⁶)₄ and Al(OR⁶)₃ where R⁶ is alkyl or aryl, and the reaction products of the alcoholates with carboxylic acids, beta-diketones and 2-(N,N-dialkylamino) alcohols;

alkaline earth metal, Bi, Pb, Sn or Al carboxylate salts; and tetravalent tin compounds, and tri- or pentavalent bismuth, antimony or arsenic compounds.

The acid-blocked alkylaminopyridine catalysts may be used in a catalytically effective amount to catalyze the reaction between a compound containing an isocyanate functional group and an active hydrogen-containing compound for making rigid, flexible or spray polyurethane foam or other polyurethane materials. A catalytically effective amount of the acid blocked alkylaminopyridine catalyst may range from about 0.01-15 parts per 100 parts of active hydrogen-containing compound, and in some embodiments from about 0.05-12.5 parts per 100 parts of active hydrogen-containing compound, and in even further embodiments from about 0.1-7.5 parts per 100 parts of active hydrogen-containing compound, and yet in even further embodiments from about 0.5-5 parts per 100 parts of active hydrogen-containing compound. In one particular embodiment, the amount of the acid blocked alkylaminopyridine catalyst may range from about 0.1-3 parts per 100 parts of active hydrogen-containing compound. In some embodiments, the acid-blocked alkylaminopyridine catalyst is the sole catalyst used for making the rigid, flexible or spray polyurethane foam (i.e. the polyurethane foam formulation is substantially free of the amine catalyst containing at least one tertiary amine group (which can also include these amine catalysts acid-blocked with a mineral acid or carboxylic acid of formula (3)) and non-amine catalyst.

In one embodiment, the compound containing an isocyanate functional group is a polyisocyanate and/or an isocyanate-terminated prepolymer.

Polyisocyanates include those represented by the general formula Q(NCO)ₐ where a is a number from 2-5, such as 2-3 and Q is an aliphatic hydrocarbon group containing 2-18 carbon atoms, a cycloaliphatic hydrocarbon group containing 5-10 carbon atoms, an araliphatic hydrocarbon group containing 8-13 carbon atoms, or an aromatic hydrocarbon group containing 6-15 carbon atoms.

Examples of polyisocyanates include, but are not limited to, ethylene diisocyanate; 1,4-tetramethylene diisocyanate; 1,6-hexamethylene diisocyanate; 1,12-dodecane diisocyanate; cyclobutane-1,3-diisocyanate; cyclohexane-1,3- and 1,4-diisocyanate, and mixtures of these isomers; isophorone diisocyanate; 2,4- and 2,6-hexahydrotoluene diisocyanate and mixtures of these isomers; dicyclohexylmethane-4,4′-diisocyanate (hydrogenated MDI, or HMDI); 1,3- and 1,4-phenylene diisocyanate; 2,4- and 2,6-toluene diisocyanate and mixtures of these isomers (TDI); diphenylmethane-2,4′-and/or -4,4′-diisocyanate (MDI); naphthylene-1,5-diisocyanate; triphenylmethane-4,4′,4″-triisocyanate; polyphenyl-polymethylene-polyisocyanates of the type which may be obtained by condensing aniline with formaldehyde, followed by phosgenation (crude MDI); norbornane diisocyanates; m- and p-isocyanatophenyl sulfonylisocyanates; perchlorinated aryl polyisocyanates; modified polyisocyanates containing carbodiimide groups, urethane groups, allophnate groups, isocyanurate groups, urea groups, or biruret groups; polyisocyanates obtained by telomerization reactions; polyisocyanates containing ester groups; and polyisocyanates containing polymeric fatty acid groups. Those skilled in the art will recognize that it is also possible to use mixtures of the polyisocyanates described above.

Isocyanate-terminated prepolymers may also be employed in the preparation of the polyurethane. Isocyanate-terminated prepolymers may be prepared by reacting an excess of polyisocyanate or mixture thereof with a minor amount of an active-hydrogen containing compound as determined by the well-known Zerewitinoff test.

In another embodiment, the active hydrogen-containing compound is a polyol. Polyols suitable for use in the present disclosure include, but are not limited to, polyalkylene ether polyols, polyester polyols, polymer polyols, a non-flammable polyol such as a phosphorus-containing polyol or a halogen-containing polyol. Such polyols may be used alone or in suitable combination as a mixture.

Polyalkylene ether polyols include poly(alkylene oxide) polymers, such as poly(ethylene oxide) and polypropylene oxide) polymers, and copolymers with terminal hydroxyl groups derived from polyhydric compounds, including diols and triols; for example, ethylene glycol, propylene glycol, 1,3-butane diol, 1,4-butane diol, 1,6-hexane diol, neopentyl glycol, diethylene glycol, dipropylene glycol, pentaerythritol, glycerol, diglycerol, trimethylol propane, and similar low molecular weight polyols.

Polyester polyols include, but are not limited to, those produced by reacting a dicarboxylic acid with an excess of a diol, for example, adipic acid with ethylene glycol or butanediol, or reaction of a lactone with an excess of a diol such as caprolactone with propylene glycol.

In addition to polyalkylene ether polyols and polyester polyols, polymer polyols are also suitable for use in the present disclosure. Polymer polyols are used in polyurethane materials to increase resistance to deformation, for example, to improve the load-bearing properties of the foam or material. Examples of polymer polyols include, but are not limited to, graft polyols or polyurea modified polyols (Polyharnstoff Dispersion polyols). Graft polyols comprise a triol in which vinyl monomers are graft copolymerized. Suitable vinyl monomers include, for example, styrene, or acrylonitrile. A polyurea modified polyol is a polyol containing a polyurea dispersion formed by the reaction of a diamine and a diisocyanate in the presence of a polyol. A variant of polyurea modified polyols are polyisocyanate poly addition (PIPA) polyols, which are formed by the in situ reaction of an isocyanate and an alkanolamine in a polyol.

The non-flammable polyol may, for example, be a phosphorus-containing polyol obtainable by adding an alkylene oxide to a phosphoric acid compound. A halogen-containing polyol may, for example, be those obtainable by ring-opening polymerization of epichlorohydrin or trichlorobutylene oxide.

The polyurethane formulation may also contain one or more halogenated olefin compounds that serve as a blowing agent. The halogenated olefin compound comprises at least one haloalkene (e.g, fluoroalkene or chlorofluoroalkene) comprising from 3 to 4 carbon atoms and at least one carbon-carbon double bond. Suitable compounds may include hydrohaloolefins such as trifluoropropenes, tetrafluoropropenes (e.g., tetrafluoropropene (1234)), pentafluoropropenes (e.g., pentafluoropropene (1225)), chlorotrifloropropenes (e.g., chlorotrifloropropene (1233)), chlorodifluoropropenes, chlorotrifluoropropenes, chlorotetrafluoropropenes, hexafluorobutenes (e.g., hexafluorobutene (1336)), or combinations thereof. In certain embodiments, the tetrafluoropropene, pentafluoropropene, and/or chlorotrifloropropene compounds have no more than one fluorine or chlorine substituent connected to the terminal carbon atom of the unsaturated carbon chain (e.g., 1,3,3,3-tetrafluoropropene (1234ze); 1,1,3,3-tetrafluoropropene, 1,2,3,3,3-pentafluoropropene (1225ye), 1,1, 1-trifluoropropene, 1,2,3,3,3-pentafluoropropene, 1,1,1,3,3-pentafluoropropene (1225zc), 1,1,2,3,3-pentafluoropropene (1225yc), (Z)- 1,1, 1,2,3-pentafluoropropene (1225yez), 1-chloro-3 ,3,3-trifluoropropene (1233zd), 1,1,1,4,4,4-hexafluorobut-2-ene (1336mzzm), or combinations thereof).

Other blowing agents that may be used in combination with the halogenated olefin compounds described above include air, nitrogen, carbon dioxide, hydrofluorocarbons (“HFCs”), alkanes, alkenes, mono-carboxylic acid salts, ketones, ethers, or combinations thereof. Suitable HFCs include 1,1-difluoroethane (HFC-152a), 1,1, 1,2-tetrafluoroethane (HFC-134a), pentafluoroethane (HFC-125), 1,1, 1,3,3-pentafluoropropane (HFC-245fa), 1,1,1,3,3-pentaflurobutane (HFC-365mfc) or combinations thereof. Suitable alkanes and alkenes include n-butane, n-pentane, isopentane, cyclopentane, 1-pentene, or combinations thereof. Suitable mono-carboxylic acid salts include methyl formate, ethyl formate, methyl acetate, or combinations thereof. Suitable ketones and ethers include acetone, dimethylether, or combinations thereof.

In addition, the polyurethane formulation may optionally include one or more auxiliary components. Examples of auxiliary components include, but are not limited to, cell stabilizers, surfactants, chain extenders, pigments, fillers, flame retardants, thermally expandable microspheres, water, thickening agents, smoke suppressants, reinforcements, antioxidants, UV stabilizers, antistatic agents, infrared radiation absorbers, dyes, mold release agents, antifungal agents, biocides or any combination thereof.

Cell stabilizers may include, for example, silicon surfactants or anionic surfactants. Examples of suitable silicon surfactants include, but are not limited to, polyalkylsiloxane, polyoxyalkylene polyol-modified dimethylpolysiloxane, alkylene glycol-modified dimethylpolysiloxane, or any combination thereof.

Suitable surfactants (or surface-active agents) include emulsifiers and foam stabilizers, such as silicone surfactants known in the art, for example, polysiloxanes, as well as various amine salts of fatty acids, such as diethylamine oleate or diethanolamine stearate, as well as sodium salts of ricinoleic acids.

Examples of chain extenders include, but are not limited to, compounds having hydroxyl or amino functional groups, such as glycols, amines, diols, and water. Further non-limiting examples of chain extenders include ethylene glycol, propylene glycol, 1,4-butanediol, 1,3-butanediol, 1,5-pentanediol, 1,6-hexanediol, 1,10-decanediol, 1,12-dodecanediol, ethoxylated hydroquinone, 1,4-cyclohexanediol, N-methylethanolamine, N-methylisopropanolamine, 4-aminocyclo-hexanol, 1,2-diaminoethane, or any mixture thereof.

Pigments may be used to color code the polyurethane materials during manufacture, to identify product grade, or to conceal yellowing. Pigments may include any suitable organic or inorganic pigments. For example, organic pigments or colorants include, but are not limited to, azo/diazo dyes, phthalocyanines, dioxazines, or carbon black. Examples of inorganic pigments include, but are not limited to, titanium dioxide, iron oxides or chromium oxide.

Fillers may be used to increase the density and load bearing properties of polyurethane foam or material. Suitable fillers include, but are not limited to, barium sulfate, carbon black or calcium carbonate.

Flame retardants can be used to reduce flammability. For example, such flame retardants include, but are not limited to, chlorinated phosphate esters, chlorinated paraffins or melamine powders.

Thermally expandable microspheres include those containing a (cyclo)aliphatic hydrocarbon. Such microspheres are generally dry, unexpanded or partially unexpanded microspheres consisting of small spherical particles with an average diameter of typically 10 to 15 micron. The sphere is formed of a gas proof polymeric shell (e.g. consisting of acrylonitrile or PVDC), encapsulating a minute drop of a (cyclo)aliphatic hydrocarbon, e.g. liquid isobutane. When these microspheres are subjected to heat at an elevated temperature level (e.g. 150° C. to 200° C.) sufficient to soften the thermoplastic shell and to volatilize the (cyclo)aliphatic hydrocarbon encapsulated therein, the resultant gas expands the shell and increases the volume of the microspheres. When expanded, the microspheres have a diameter 3.5 to 4 times their original diameter as a consequence of which their expanded volume is about 50 to 60 times greater than their initial volume in the unexpanded state. Examples of such microspheres are the EXPANCEL®-DU microspheres which are marketed by AKZO Nobel Industries of Sweden.

The methods for producing a polyurethane material from a polyurethane formulation according to the present disclosure are well known to those skilled in the art and can be found in, for example, U.S. Pat. Nos. 5,420,170, 5,648,447, 6,107,359, 6,552,100, 6,737,471 and 6,790,872, the contents of which are hereby incorporated by reference. Various types of polyurethane materials can be made, such as rigid foams, flexible foams, semi-flexible foams, microcellular elastomers, backings for textiles, spray foams or elastomers, cast elastomers, polyurethane-isocyanurate foams, reaction injection molded polymers, structural reaction injection molded polymers and the like.

A non-limiting example of a general flexible polyurethane foam formulation having a 15-150 kg/m³ density (e.g. automotive seating) containing the acid-blocked alkylaminopyridine catalyst may comprise the following components in parts by weight

| Flexible Foam Formulation | pbw |
|---|---|
| Polyol | 20-100 |
| Surfactant | 0.3-3 |
| Water | 1-6 |
| Crosslinker | 0-3 |
| Acid-blocked alkylaminopyridine catalyst | 0.2-2.5 |
| Isocyanate Index | 70-115 |

A non-limiting example of a general rigid polyurethane foam formulation having a 15-70 kg/m³ density containing the acid-blocked alkylaminopyridine catalyst may comprise the following components in parts by weight (pbw):

| Rigid Foam Formulation | Pbw |
|---|---|
| Polyol | 100 |
| Surfactant | 1-3 |
| Blowing Agent | 20-40 |
| Water | 0-3 |
| Acid-blocked alkylaminopyridine catalyst | 0.5-3 |
| Isocyanate Index | 80-400 |

The amount of the compound containing an isocyanate functional group is not limited, but will generally be within those ranges known to one skilled in the art. An exemplary range given above is indicated by reference to Isocyanate Index which is defined as the number of equivalents of isocyanate divided by the total number of equivalents of active hydrogen, multiplied by 100.

Thus, in yet another embodiment, the present disclosure provides a method for producing a polyurethane material which comprises contacting the compound containing an isocyanate functional group, an active hydrogen-containing compound, halogenated olefin and optional auxiliary components in the presence of the acid-blocked alkylaminopyridine catalysts according to the present disclosure.

In one particular embodiment, the polyurethane material is a rigid, flexible or spray foam prepared by bringing together at least one polyol and at least one polyisocyanate in the presence of the acid-blocked alkylaminopyridine catalyst and halogenated olefin compound to form a reaction mixture and subjecting the reaction mixture to conditions sufficient to cause the polyol to react with the polyisocyanate. The polyol, polyisocyanate, acid-blocked alkylaminopyridine catalyst and halogenated olefin compound may be heated prior to mixing them and forming the reaction mixture. In other embodiments, the polyol, polyisocyanate, acid-blocked alkylaminopyridine catalyst and halogenated olefin compound are mixed at ambient temperature (for e.g. from about 15°-40° C.) and heat may be applied to the reaction mixture, but in some embodiments, applying heat may not be necessary. The polyurethane foam may be made in a free rise (slabstock) process in which the foam is free to rise under minimal or no vertical constraints. Alternatively, molded foam may be made by introducing the reaction mixture in a closed mold and allowing it to foam within the mold. The particular polyol and polyisocyanate are selected with the desired characteristics of the resulting foam. Other auxiliary components useful in making polyurethane foams, such as those described above, may also be included to produce a particular type of foam.

According to another embodiment, a polyurethane material may be produced in a one-step process in which an A-side reactant is reacted with a B-side reactant. The A-side reactant may comprise a polyisocyanate while the B-side reactant may comprise a polyol, the acid-blocked alkylaminopyridine catalyst and halogenated olefin compound. In some embodiments, the A-side and/or B-side may also optionally contain other auxiliary components such as those described above.

The polyurethane materials produced may be used in a variety of applications, such as, a precoat; a backing material for carpet; building composites; insulation; spray foam insulation; applications requiring use of impingement mix spray guns; urethane/urea hybrid elastomers; vehicle interior and exterior parts such as bed liners, dashboards, door panels, and steering wheels; flexible foams (such as furniture foams and vehicle component foams); integral skin foams; rigid spray foams; rigid pour-in-place foams; coatings; adhesives; sealants; filament winding; and other polyurethane composite, foams, elastomers, resins, and reaction injection molding (RIM) applications

The present disclosure will now be further described with reference to the following non-limiting examples.

### EXAMPLES

### Example 1

A series of experiments were done using a standard closed cell formulation as shown in Table 1.

| Component | Percent |
|---|---|
| Terol 649 polyol | 44.20 |
| Jeffol ®-425-X polyol | 14.00 |
| Jeffol ®SG-522 polyol | 7.00 |
| RB-79 (PHT4-Diol) | 6.00 |
| TCPP flame retardant | 11.00 |
| Dabco ®DC-193 silicone | 1.00 |
| surfactant | |
| Solstice ® LBA 1233zd(E) | 10.00 |
| blowing agent | |
| water | 1.80 |
| Catalyst* | 2-5 |
| Total | 100.00 |

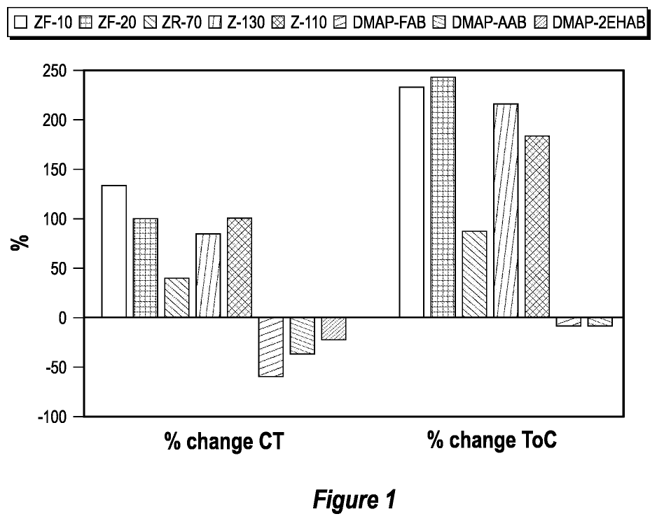

To make closed cell rigid foams, 50 g of this formulation (the B-side) was mixed with 50 g of Rubinate® M polymeric MDI in a cup and allowed to freely rise. Different stages of the rise profile were measured with a stop-watch and recorded for each foam. Typically, “blocking” an amine catalyst with an acid greatly slows down its reactivity, especially on the “front-end” or blowing reaction. For example, a very fast front-end catalyst is JEFFCAT® ZF-20 catalyst, manufactured by Huntsman Corporation. In its neutral, un-blocked form, when used in an amount of 4% of the B-side and mixed in a cup with an isocyanate, it was found only 2-3 seconds passed before the mixture creamed and 6 seconds passed before the foam reached the top of the cup (“ToC”). However, when JEFFCAT® ZF-20 is blocked with formic acid and used at an equivalent amount, the cream time of the foam was found to drop to 5-6 seconds and the ToC time dropped to 20 seconds. Thus, acid-blocking this amine catalyst drastically slowed down the beginning of the foam reaction. This trend is fairly constantly seen for most other traditional polyurethane catalysts as shown in FIG. 1, which shows that every traditional JEFFCAT® amine catalyst is much slower when acid-blocked. Surprisingly, acid-blocking dimethylaminopyridine (“DMAP”) was found to not only speed up the cream time, but had virtually no effect on the ToC time, as shown in FIG. 1. In addition, it was found combining the acid-blocked DMAP catalyst with an acid-blocked traditional JEFFCAT® polyurethane catalyst reversed the drop in cream time.

This is a very unique and unexpected discovery, since the pKa of DMAP is not significantly different than that for a typical amine catalyst.

### Example 2

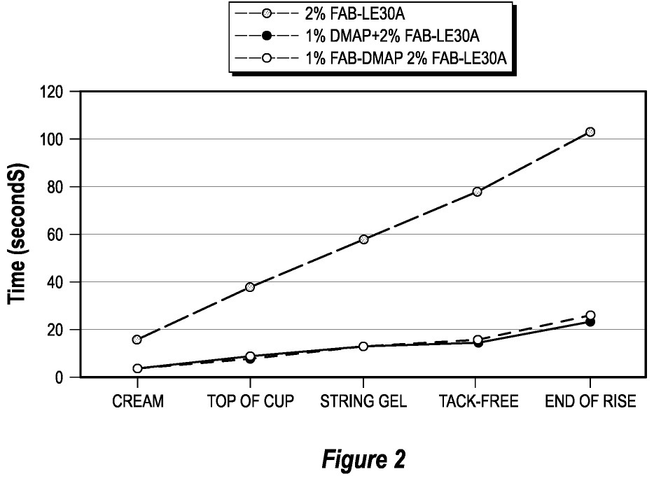

In Example 2, the same polyol resin blend from example 1 was used, and DMAP or formic acid-blocked (FAB) DMAP was used to reverse the slowdown in reactivity seen when a fully formic acid-blocked strong blowing catalyst, JEFFCAT® LE-30A, was used. As shown in FIG. 2, the formic acid blocked JEFFCAT® LE-30A is quite slow, with a cream time of 16 seconds when used alone at 2% in the B-side. Conversely, it can be seen that the use of the DMAP catalyst, acid-blocked or not, had a strong accelerating effect on the commercially available acid-blocked catalyst when added into the formulation at 1%. This is again a surprising result, showing that the acid-blocked DMAP catalyst provided as much reaction catalysis as the un-blocked version.

### Example 3

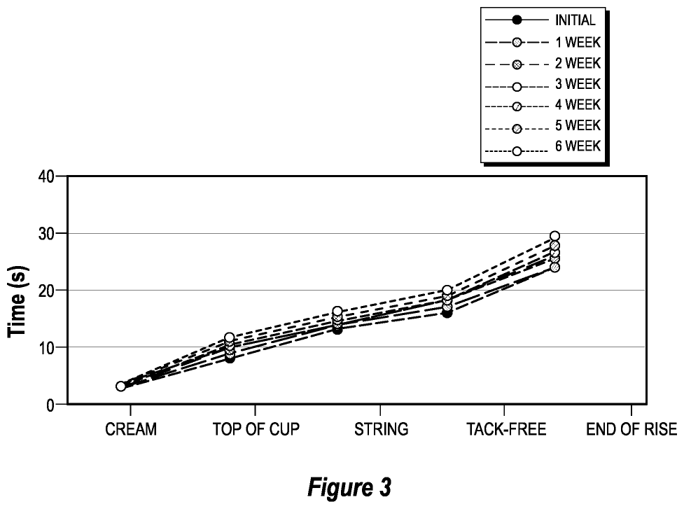

Acid-blocked catalysts can play an important role in creating stable polyol resin blends when HFO blowing agents are used. The acid salts of the amine catalysts are much less reactive with the HFO blowing agents and slow down the degradation in the system, but also typically slow down the front end “creaming” reaction as well, which is undesirable. FIG. 3 shows the change in the reaction profile of polyurethane foam made with a heat-aged polyol resin containing an inventive catalyst blend containing formic acid-blocked DMAP, JEFFCAT® Z-110 catalyst, JEFFCAT® DMDEE catalyst and 1,2-dimethylimidazole. The polyol resin was the same composition used in Example 1 and 2, except it was stored at 50° C. for 6 weeks, with foam profile measurements taken once per week. In general, when a formulated B-side polyol resin blend experiences degradation, the front-end of the reaction will drop off significantly, with cream times increasing 2-4 times as compared to the original cream time over 6 weeks of storage at 50° C. However, as shown in FIG. 3 and seemingly in all cases where the inventive acid-blocked alkylaminopyridine catalyst was used, the cream time did not change or showed a very small change, even if the back-end of the reaction did drift.

While the foregoing is directed to various embodiment s of the present disclosure, other and further embodiments of the disclosure may be devised without departing from the basic scope thereof, and the scope thereof is determined by the claims that follow.

What is claimed is:

1. A polyurethane formulation comprising: (a) an acid-blocked alkylaminopyridine catalyst obtained by contacting (i) at least one alkylaminopyridine of formula (1) or (2) 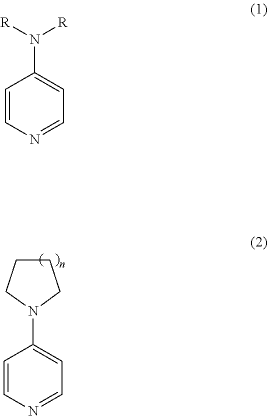
with (ii) at least one of a mineral acid or a carboxylic acid of formula (3) 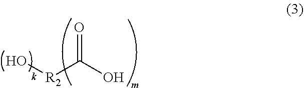
where each R is independently an alkyl group, hydroxyethyl group or hydroxypropyl group, n is an integer from 1 to 2, R₂ is hydrogen, an alkyl group, an alkenyl group, cycloaliphatic group, an aromatic group, or alkylaromatic group, k and m are independently an integer from 1 to 3 with the proviso that k+m≥1 and when k=1 and m=0, R is an aromatic group or alkylaromatic; (b) a compound containing an isocyanate functional group; (c) an active hydrogen-containing compound; and (d) a halogenated olefin compound.

2. The polyurethane formulation of claim 1, wherein each R is independently methyl, ethyl, n-propyl, iso-propyl, propyl or butyl.

3. The polyurethane formulation of claim 2, wherein each R is methyl.

4. The polyurethane formulation of claim 1 further comprising an amine catalyst containing at least one tertiary amine group and/or a non-amine catalyst.

5. The polyurethane formulation of claim 4, wherein the amine catalyst containing at least one tertiary amine group is further contacted with a mineral acid or a carboxylic acid of formula (3) 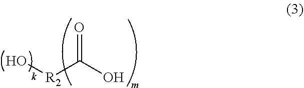
where R₂ is hydrogen, an alkyl group, an alkenyl group, cycloaliphatic group, an aromatic group, or alkylaromatic group, k and m are independently an integer from 1 to 3 with the proviso that k+m≥1 and when k=1 and m=0, R₂ is an aromatic group or alkylaromatic group.

6. A catalyst package for use in forming a polyurethane material comprising: (a) an acid-blocked alkylaminopyridine catalyst obtained by contacting (i) at least one alkylaminopyridine of formula (1) or (2) 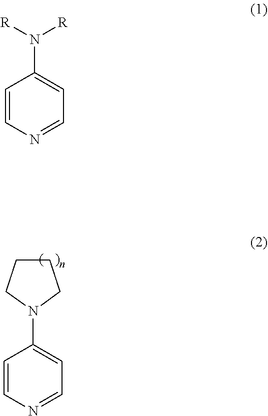
with (ii) at least one of a mineral acid or a carboxylic acid of formula (3) 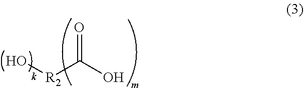
where each R is independently an alkyl group, hydroxyethyl group or hydroxypropyl group, n is an integer from 1 to 2, R₂ is hydrogen, an alkyl group, an alkenyl group, cycloaliphatic group, an aromatic group, or alkylaromatic group, k and m are independently an integer from 1 to 3 with the proviso that k+m≥1 and when k=1 and m=0, R is an aromatic group or alkylaromatic; (b) and a halogenated olefin compound.

7. The catalyst package of claim 6, further comprising an amine catalyst containing at least one tertiary amine group.

8. A method for producing a polyurethane material comprising contacting a compound containing an isocyanate functional group, an active hydrogen-containing compound and optional auxiliary components in the presence of at least one acid-blocked alkylaminopyridine obtained by contacting (i) at least one alkylaminopyridine of formula (1) or (2) 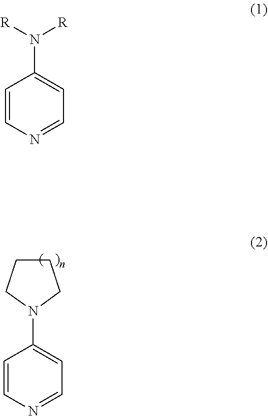
with (ii) at least one of a mineral acid or a carboxylic acid of formula (3) 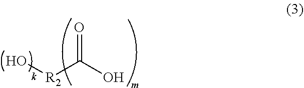
where each R is independently an alkyl group, hydroxyethyl group or hydroxypropyl group, n is an integer from 1 to 2, R₂ is hydrogen, an alkyl group, an alkenyl group, cycloaliphatic group, an aromatic group, or alkylaromatic group, k and m are independently an integer from 1 to 3 with the proviso that k+m≥1 and when k=1 and m=0, R is an aromatic group or alkylaromatic; (b) and a halogenated olefin compound.

9. A polyurethane material produced according to the method of claim 8.

10. The polyurethane material of claim 9, wherein the polyurethane material is a rigid foam, a flexible foam or a spray foam.

11. The polyurethane material of claim 9 for use as a precoat, a backing material for carpet, a building composite, insulation, a spray foam insulation, a urethane/urea hybrid elastomers; in vehicle interior and exterior parts, a flexible foam, an integral skin foam, a rigid spray foam, a rigid pour-in-place foam; a coating; an adhesive, a sealant, or a filament winding.
